(19) United States
(12) Patent Application Publication
(10) Pub. No.: US 2008/0295377 A1
(43) Pub. Date: Dec. 4, 2008

(54) STICKERS WITH POCKETS

(76) Inventors: Marilyn L. Bollinger, Wilmington, NC (US); Howard N. Bollinger, Wilmington, NC (US)

Correspondence Address: WOOD, HERRON & EVANS, LLP, 2700 CAREW TOWER, 441 VINE STREET, CINCINNATI, OH, 45202, US

(21) Appl. No.: 11/754,688

(22) Filed: May 29, 2007

(51) Int. Cl. G09F 3/18

(52) U.S. Cl. 40/661.09

(57) ABSTRACT

The invention provides an adhesive-backed sticker for adhering to a mounting surface and forming a pocket for insertion of an object. The sticker can be folded to incorporate one or more pockets within a perimeter of a mounting section and/or extending beyond the perimeter of the mounting section. The sticker may include sticker liners that remain in place throughout use. Apertures may be provided to receive objects and matching apertures may be provided to keep the object stable. Non-adhesive objects can be inserted into the one or more pockets and removed therefrom, as desired.

### FIELD OF THE INVENTION

This invention relates to an adhesive sticker having one or more pockets formed integrally therewith for receiving one or more objects.

### BACKGROUND OF THE INVENTION

Stickers have a wide variety of uses, including informational labels, children's play stickers, and numerous uses in between. Some labels are permanently adhered or substantially permanently adhered to a mounting surface, while other stickers include an adhesive that allows the sticker to be removed and re-adhered to a mounting surface, where such adhesives are well known in the art. Stickers may be mass produced by a continuous process that includes die cutting a sticker substrate to a desired shape, printing desired markings on a front surface of the sticker, applying adhesive to the back surface of the sticker, and placing the sticker adhesive-side down onto a release liner. The consumer can then remove the sticker from its release liner and place it on a desired surface. Given the vast variety of uses for stickers, any improvement to a sticker design can have far reaching benefits in numerous industries. There is thus a need for an improvement to a sticker design to increase its usefulness.

### SUMMARY OF THE INVENTION

The invention provides an adhesive-backed sticker for adhering to a mounting surface and forming a pocket for insertion of an object. In accordance with one embodiment of the invention the sticker includes a mounting section having a main portion and at least one adhering portion along a perimeter of the mounting section, the mounting section further having a front surface and a back surface with an adhesive applied to the back surface for adhering at least the main portion of the mounting section to a mounting surface. The sticker further includes at least one pocket-forming section extending beyond the perimeter of the mounting section adjacent the adhering portion. The pocket-forming section includes a pocket portion, and a bisecting fold line dividing the pocket portion into a first section adjacent the adhering portion and a second section remote from the adhering portion, and an opposing end portion opposite the adhering portion and either adjacent to the second section or partially coincident with the second section. An adhesive resides on the opposing end portion or the adhering portion, or both. The pocket portion is foldable at the bisecting fold line for adhering the opposing end portion and the adhering portion to each other whereby a pocket is formed between the first section and the second section of the pocket portion. In certain embodiments, the mounting section and the pocket-forming section are formed from a single integral piece, and in other embodiments, the mounting section and the pocket-forming section are formed from two separate pieces that are adapted to be adhered together.

According to another embodiment, an adhesive-backed sticker is provided having two mounting sections each with a front surface and a back surface and an adhesive applied to each back surface for adhering the mounting sections to a mounting surface. A main portion of a pocket-forming section is located between the two mounting sections and has a front surface and a back surface with an adhesive applied to the back surface. A lip portion extends beyond a perimeter of the main portion not bound by the two mounting sections, with a fold line therebetween. A sticker liner is adhered to the pocket-forming section, wherein upon adhering the mounting sections to a mounting surface, a through-pocket is formed between the mounting surface and the pocket-forming section in registry with the main portion. The lip section is foldable along the fold line away from the mounting surface to provide a radiused edge for insertion of an object into the through-pocket.

According to another embodiment a two-piece adhesive-backed sticker is provided for adhering to a mounting surface and forming a pocket. This includes a mounting section having a perimeter, a front surface, and a back surface with an adhesive applied to the back surface for adhering at least a portion of the mounting section to a mounting surface, wherein the mounting section further includes an opening within the perimeter. Also included is a separate pocket-forming section having a front surface and a back surface and a pocket portion and a flap section with a fold line therebetween, wherein the flap section extends beyond a perimeter of the pocket portion in a direction perpendicular to the fold line. In this embodiment the pocket-forming section is foldable along the fold line such that either the pocket portion or the flap section is insertable through the opening of the mounting section, and the back surface of either the pocket portion or the flap section inserted through the opening is adherable to a portion of the back surface of the mounting section.

According to another embodiment, an adhesive-backed sticker is provided for adhering to a mounting surface and forming a pocket. This includes a mounting section having a main portion and at least one adhering portion along a perimeter of the mounting section. The mounting section has a front surface and a back surface with an adhesive applied to the back surface for adhering at least the main portion of the mounting section to a mounting surface. At least one pocket extends beyond the perimeter of the mounting section adjacent to the adhering portion. The pocket is formed from a pocket-forming section having a pocket portion, a bisecting fold line dividing the pocket portion into a first section adjacent the adhering portion and a second section remote from the adhering portion, and an opposing end portion opposite the adhering portion and either adjacent to the second section or partially coincident with the second section. Adhesive is applied between the opposing end portion and the adhering portion, wherein the pocket portion is folded at the bisecting fold line and the opposing end portion and the adhering portion are adhered to each other thereby forming the pocket between the first section and the second section of the pocket portion.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIGS. 1A and 1B are perspective views of a two-piece adhesive-backed sticker according to one embodiment of the invention having a pocket adhered to a mounting section such that the pocket extends beyond the perimeter of the mounting section, with FIG. 1A depicting an assembled sticker on a release liner, and FIG. 1B depicting an unassembled sticker.

FIGS. 2A-2D depict in plan and perspective views a one-piece adhesive-backed sticker according to another embodiment of the invention having a pocket extending beyond the perimeter of a mounting section.

FIGS. 3A-3C depict in perspective view a two-piece sticker according to yet another embodiment of the invention with a pocket formed within the perimeter of the mounting section between a mounting surface and the mounting section.

FIGS. 4A and 4B depict in perspective view a two-piece sticker according to still another embodiment of the invention having a pocket formed within the perimeter of the mounting section but external to the mounting section such that the mounting section is intermediate the mounting surface and the pocket.

FIGS. 5A and 5B depict in perspective view a sticker having two mounting sections and an intermediate through-pocket, according to one embodiment of the invention.

FIGS. 6A-6D depict in perspective view a sticker according to another embodiment of the invention having a through-pocket extending beyond the perimeter of a mounting section.

FIGS. 7A-7C depict in perspective and plan views a sticker according to yet another embodiment of the invention having a pocket extending beyond the perimeter of a mounting section.

FIGS. 8A-8D depict in perspective view a sticker according to another embodiment of the invention having a pocket extending beyond the perimeter of a mounting section with object apertures and opposing apertures for receiving and securing the object.

FIGS. 9A-9C depict in perspective view a sticker according to another embodiment of the invention having a pocket extending beyond the perimeter of a mounting section with an object aperture for receiving an object.

### DETAILED DESCRIPTION

The present invention provides an adhesive-backed sticker with either permanent or releasable type adhesive, where the sticker can be folded to incorporate pockets within a perimeter of a mounting section and/or extending beyond the perimeter of the mounting section. Non-adhesive objects can then be inserted into the pocket and removed therefrom, as desired. The invention may be best understood with reference to the figures wherein like reference numerals are used throughout the figures to refer to like parts.

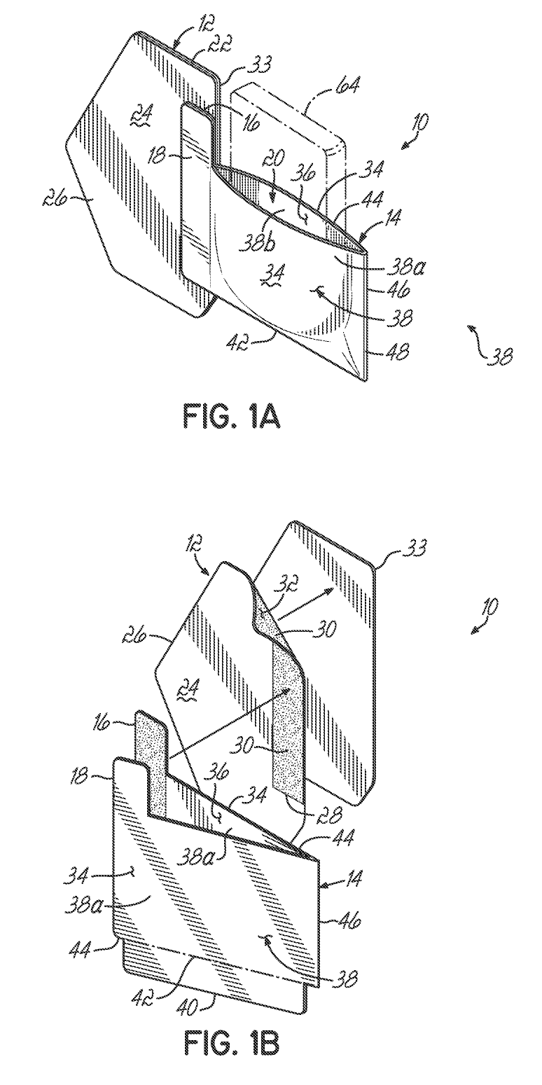

In accordance with one embodiment of the invention, FIG. 1A is a perspective view of an assembled two-piece sticker 10 having a mounting section 12 and a separate pocket-forming section 14 adhered to the mounting section 12 forming a pocket 20 extending beyond the perimeter 22 of the mounting section 12. While this embodiment is described as a sticker having a mounting section and a single pocket-forming section, it may be appreciated that a plurality of pocket-forming sections could be attached to the mounting section 14 so as to create a sticker having a mounting section and a plurality of pockets.

FIG. 1B depicts in perspective view the unassembled mounting section 12 and separate pocket-forming section 14 used to form the sticker 10 of FIG. 1A. The front surface 24 of mounting section 12 consists of a main portion 26 and an adhering portion 28 with an adhesive 30 applied to the adhering portion 28. An adhesive 30 is also applied to the back surface 32 of the mounting section 12. A release liner 33 is provided, onto which the mounting section 12 may be releasably adhered when the sticker 10 is not mounted to a mounting surface. The pocket-forming section 14 also has a front surface 34 and a back surface 36. The pocket-forming section further comprises a pocket portion 38 defined by a perimeter 44 and extending between an opposing end portion 16 and a second end portion 18. An adhesive 30 is applied to the back surface 36 of at least one of the opposing end portion 16 or the second end portion 18 (shown applied to the back surface 36 of opposing end portion 16). Pocket-forming section 14 further comprises a fold line 46 bisecting the pocket portion 38 in a direction parallel the opposing end portions 16 and the second end portion 18 to form a first section 38a and a second section 38b. The pocket-forming section 14 further comprises a lower flap section 40 and a fold line 42 separating lower flap section 40 from pocket portion 38 such that lower flap section 40 extends beyond the perimeter 44 of the pocket portion 38 on one side of the bisecting fold line 46 in a direction perpendicular to fold line 42.

Upon folding the pocket portion 38 along bisecting fold line 46 and then folding lower flap section 40 along fold line 42, fold lines 42, 46 form part of the perimeter 48 of pocket 20, as shown in FIG. 1A. Additionally, upon folding the pocket portion 38 along bisecting fold line 46, the back surface 36 of opposing end portion 16 is adhered to the back surface 36 of second end portion 18. Additionally, an adhesive 30 is applied to the back surface 36 (not shown) of the flap section 40 such that upon folding flap section 40 along fold line 42 the back surface 36 of flap section 40 is adhered to the front surface 34 of pocket portion 38 creating a pocket 20, as shown in FIG. 1A. The front surface 34 of end portion 16 of pocket-forming section 14 is adhered to adhering portion 28 on the front surface 24 of mounting section 12 to form a sticker 10 having a pocket 20 extending from the perimeter 22 of the mounting section 12.

Although FIG. 1B shows mounting section 12 having an adhering portion 28 with an adhesive 30 applied thereto, it may be appreciated that adhesive 30 could alternatively be applied to the front surface 34 of opposing end portion 16 of the pocket-forming section 14 rather than to the adhering portion 28 of the mounting section 12 in order to attach the pocket-forming section 14 to the mounting section 12. In another alternative, adhesive 30 could be applied to the back surfaces 36 of both opposing end portion 16 and second end portion 18, or just to the back surface 36 of second end portion 18, wherein the end portions 16, 18 could then be attached by adhering end portion 18 to adhering portion 28 and adhering end portion 16 to back surface 32.

In the embodiment shown, flap section 40 functions to provide a closed bottom for the pocket 20 to retain an object 64 inserted therein. In an alternative embodiment, flap section 40 could be eliminated such that the pocket is a through-pocket.

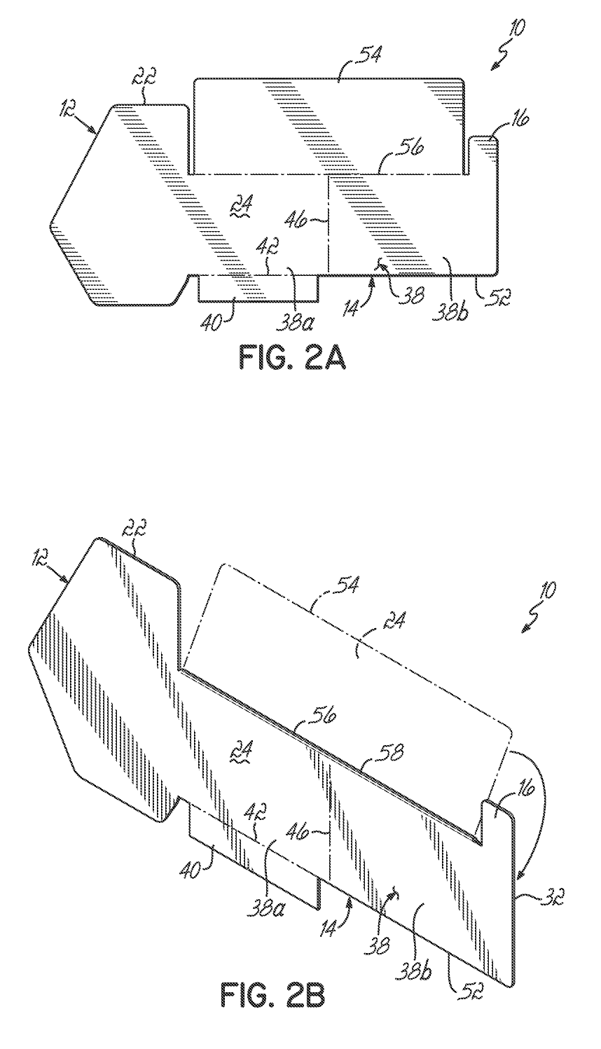

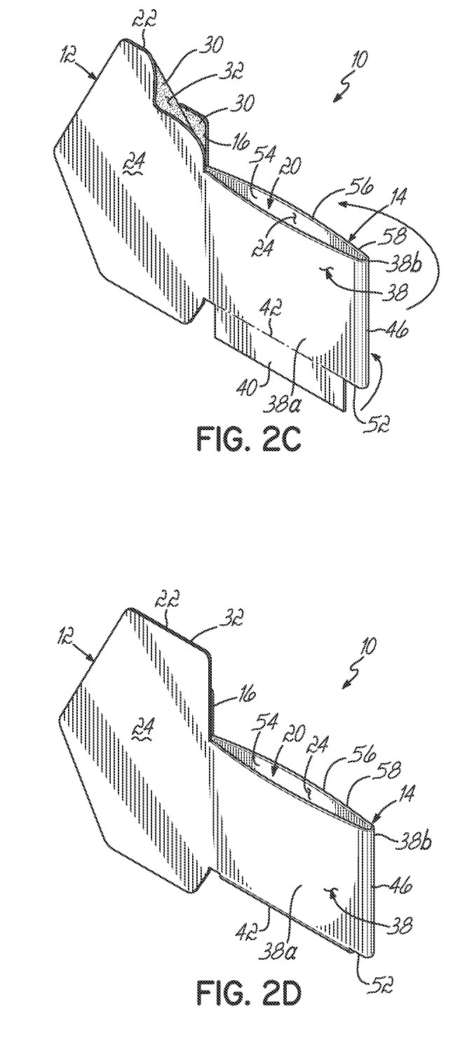

In accordance with another embodiment of the invention, FIGS. 2A and 2B depict in plan and perspective views, respectively, a one-piece sticker 10 having a front surface 24 and a back surface 32 with an adhesive 30 (not shown) applied to the back surface 32. The sticker 10 comprises a mounting section 12 and a pocket-forming section 14 extending integrally from the perimeter 22 of the mounting section 12. Pocket-forming section 14 comprises a pocket portion 38, an opposing end portion 16 opposite mounting section 12 with pocket portion 38 therebetween, a lower flap section 40, and an upper flap section 54. Pocket-forming section 14 further comprises a fold line 46 bisecting the pocket portion 38 in a direction parallel to opposing end portion 16 to form a first section 38a and a second section 38b. Pocket-forming section 14 further comprises a fold line 42 separating lower flap section 40 from pocket portion 38 such that lower flap section 40 extends beyond the lower perimeter 52 of the pocket portion 38 on one side of the bisecting fold line 46 in a direction perpendicular to fold line 42. Pocket-forming section 14 further comprises a fold line 56 parallel to fold line 42 and separating upper flap section 54 from pocket portion 38 such that upper flap section 54 extends beyond the upper perimeter 58 of pocket portion 38 on both sides of the bisecting fold line 46 in a direction perpendicular to fold line 56. While this embodiment describes a one-piece sticker substrate having a mounting section and a singular pocket-forming section extending beyond the perimeter of the mounting section, a person ordinarily skilled in the art may appreciate that a plurality of pocket-forming sections may extend beyond the perimeter of the mounting section to form a plurality of pockets.

Upon folding upper flap section 54 along fold line 56, the back surface 32 of upper flap section 54 is adhered to the back surface 32 of pocket portion 38, and fold line 56 forms the upper perimeter 58 of pocket portion 38, as shown in perspective view in FIG. 2B. Upon folding pocket portion 38 along bisecting fold line 46, the back surface 32 of opposing end portion 16 is adhered to the back surface 32 of mounting section 12 such that the front surface 24 of upper flap section 54, which has no adhesive applied thereto, is folded onto itself, as shown in perspective view in FIG. 2C. Upon folding lower flap section 40 along fold line 42, the back surface 32 of lower flap section 40 is adhered to the front surface 24 of pocket portion 38 such that fold line 42 forms part of the lower perimeter 52 of pocket portion 38 and a pocket 20 extending beyond the perimeter 22 of mounting section 12 is formed, as shown in perspective view in FIG. 2D. In an alternative embodiment, flap section 40 is eliminated such that the pocket is a through-pocket.

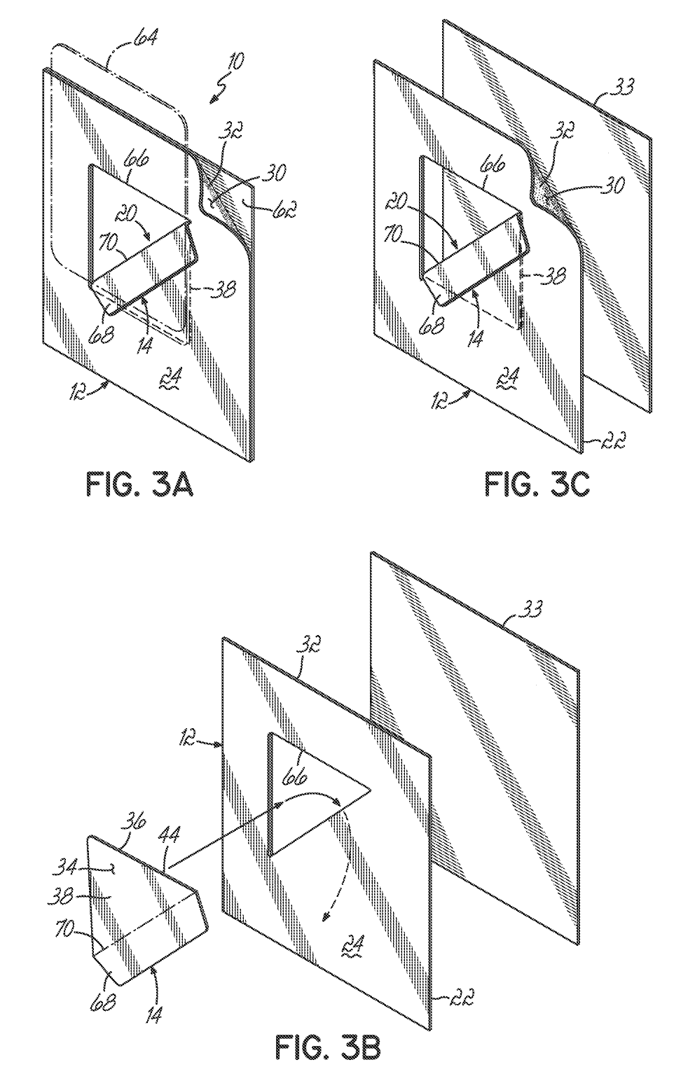

FIGS. 3A-3C depict another embodiment of the invention, which is a sticker 10 of two-piece construction having an interior pocket 20. FIG. 3A depicts in perspective view the assembled two-piece sticker 10 having a pocket 20 formed between a mounting section 12 and the mounting surface 62 in registry with at least the portion of the pocket-forming section 14 adhered to the mounting section 12. When the sticker 10 is applied to the mounting surface 62, an object 64 can be placed within the pocket 20 and removed therefrom.

FIG. 3B depicts in exploded perspective view the mounting section 12 having a front surface 24 and a back surface 32, and a separate pocket-forming section 14 having a front surface 34 and a back surface 36 with an adhesive 30 applied to the back surfaces 32, 36. The mounting section 12 has an opening 66 within the perimeter 22 of the mounting section 12. Although this embodiment of the invention is depicted with a triangular opening, it may be appreciated that openings of other shapes (e.g. rectangular, semi-circular, etc.) may be provided within the perimeter 22 of the mounting section 12. The pocket-forming section 14 comprises a pocket portion 38 having a similar shape and size as the opening 66 in the mounting section 12 and a flap section 68 with a fold line 70 therebetween. The flap section 68 extends beyond the perimeter 44 of pocket portion 38 in a direction perpendicular to fold line 70 such that upon folding flap section 68 along fold line 70, fold line 70 forms part of the perimeter 44 of pocket portion 38. Again, a releasable liner 33 may be provided to adhere sticker 10 onto when not mounted to a mounting surface 62.

FIG. 3C depicts in perspective view pocket-forming section 14 folded along fold line 70 and adhered to mounting section 12 such that the back surface 36 of flap section 68 is adhered to the front surface 24 of mounting section 12 and the back surface 36 of the pocket portion 38 is adhered to the back surface 32 of mounting section 12 adjacent the opening 66. From this arrangement, it may be appreciated that adhesive 30 could be applied only to the back surface 36 of flap section 68 of the pocket-forming section 14 such that the back surface 36 of the pocket portion 38 does not have adhesive 30 applied to it. The adhesive 30 on the back surface 32 of mounting section 12 provides adhesion of the pocket portion 38 to the back surface 32. In yet another embodiment, adhesive 30 may be provided to only a portion of back surface 32 for mounting to a mounting surface 62, and no adhesive 30 need be provided between the back surface 32 and pocket portion 38. In any of these alternatives, when sticker 10 is applied to a mounting surface 62, a pocket 20 is formed between the mounting section 12 and the mounting surface 62 in registry with the pocket portion 38 adhered to the mounting section 12 by flap section 68. While this embodiment is described as having a singular pocket within the perimeter of the mounting section, it may be appreciated that a plurality of pockets 20 may be provided within the perimeter of the mounting section 12. It may be further appreciated that the embodiments in FIGS. 1A-3C may be combined to provide a plurality of pockets 20 within and/or extending from the perimeter 22 of mounting section 12.

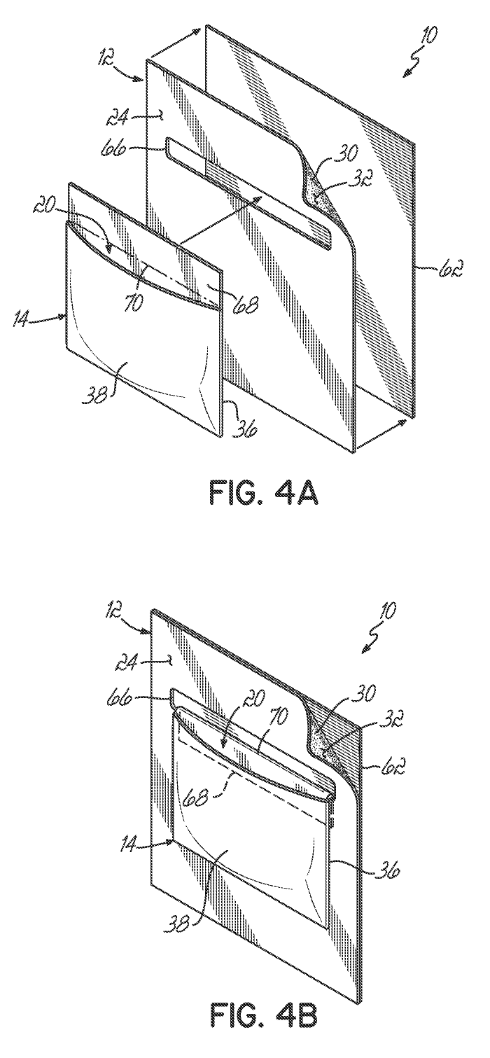

FIGS. 4A-4B depict in perspective views a two-piece sticker 10 having an external pocket 20 according to yet another embodiment of the invention. As shown in exploded perspective view in FIG. 4A, the mounting section 12 has a front surface 24 and a back surface 32 with an adhesive 30 applied to the back surface 32 such that mounting section 12 may be adhered to a mounting surface 62. An opening 66 is cut within the perimeter 22 of mounting section 12. Although this embodiment shows a singular rectangular opening, it may be appreciated that an opening of a variety of shapes and a plurality of such openings could be provided. The pocket-forming section 14 has a pocket 20 and a flap section 68 with a fold line 70 therebetween. Flap section 68 extends from the pocket 20 in a direction perpendicular to fold line 70. An adhesive 30 may be applied or may not be applied to the back surface 36 of pocket-forming section 14. Flap section 68 is sized such that it may pass through the opening 66 of mounting section 12.

FIG. 4B depicts in perspective view mounting section 12 adhered to the mounting surface 62. Prior to mounting, pocket-forming section 14 is folded along a fold line 70 and adhered to mounting section 12 through the opening 66 such that the back surface 36 of flap section 68 is adhered to the back surface 32 of mounting section 12. Upon mounting, a pocket 20 is positioned external mounting section 12 with mounting section 12 intermediate pocket 20 and mounting surface 62.

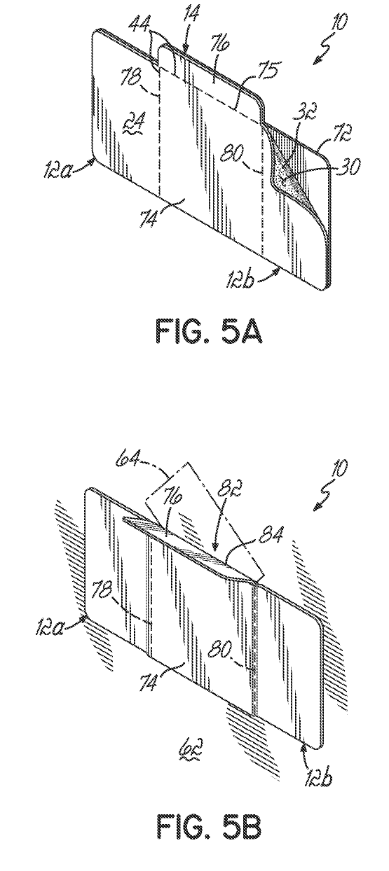

FIGS. 5A-5B depict in perspective view still another embodiment of the invention, in which a liner is used to form a sticker 10 having a through-pocket 82. FIG. 5A depicts in perspective view a sticker 10 having a front surface 24 and back surface 32 with an adhesive 30 applied to the back surface 32 and the back surface 32 adhered to a sticker liner 72. The sticker 10 comprises two mounting sections 12a, 12b and a pocket-forming section 14 intermediate the two mounting sections 12a, 12b. The pocket-forming section 14 is comprised of a main portion 74 intermediate the two mounting sections 12a, 12b and a lip portion 76 with a fold line 75 therebetween, with the lip portion 76 extending beyond the perimeter 44 of the main portion 74 not bound by the two mounting sections 12a, 12b. The sticker liner 72 is kiss-cut (i.e., the liner is cut but the sticker is not cut) along cut lines 78, 80 at the boundaries between the pocket-forming section 14 and the two adjacent mounting sections 12a, 12b.

FIG. 5B depicts in perspective view the sticker 10 with the sticker liner 72 removed from the back surfaces 32 of the two mounting sections 12a, 12b and the sticker 10 adhered to a mounting surface 62 such that a through-pocket 82 is created between the mounting surface 62 and sticker liner 72 adhered to the back surface 32 of pocket-forming section 14. The mounting surface 62, for example, could be a wallet. The lip section 76 of pocket-forming section 14 can be bent away from the mounting surface 62 along fold line 75 to provide a radiused edge 84 allowing for easy insertion of a desired object 64 into the through-pocket 82. The object may be, for example, a coupon or a business card.

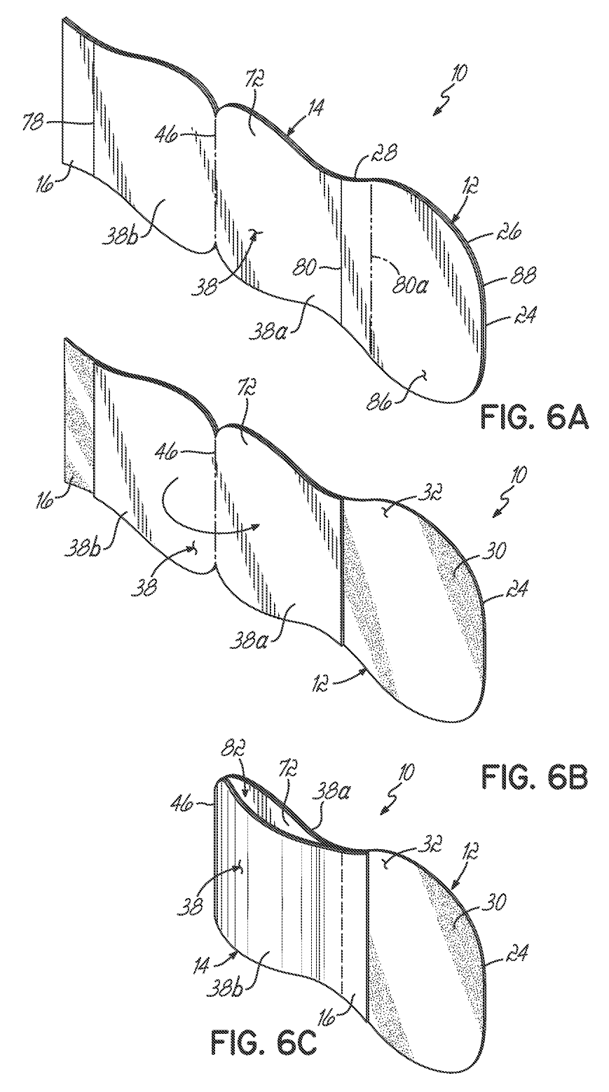

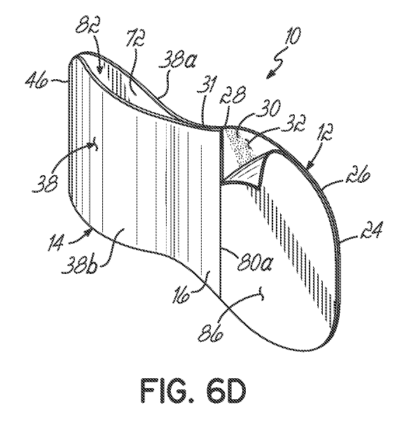

FIGS. 6A-6C depict in perspective view a sticker 10 in accordance with another embodiment of the invention, in which the sticker liner 72 is again used to form a through-pocket 82. As shown in FIG. 6A, the sticker 10 has a front surface 24 and a back surface 32 with an adhesive 30 applied to the back surface 32 of the sticker 10, as shown and/or described in prior embodiments. Sticker liner 72 has a front surface 86 and a back surface 88 (not shown) with the back surface 88 adhered to the back surface 32 of a sticker 10. The sticker 10 comprises a mounting section 12 and a pocket-forming section 14 adjacent to mounting section 12. The pocket-forming section 14 comprises a pocket portion 38 and an opposing end portion 16 opposite mounting section 12 with pocket portion 38 therebetween. The sticker liner 72 has a kiss-cut line 78 at the boundary between pocket portion 38 and opposing end portion 16 and a kiss-cut line 80 at the boundary between pocket portion 38 and mounting section 12. Pocket-forming section 14 further comprises a bisecting fold line 46 parallel to kiss-cut lines 78, 80 and dividing pocket portion 38 into a first section 38a and a second section 38b.

FIG. 6B depicts in perspective view the back surface 32 of the sticker 10 with the sticker liner 72 removed from the mounting section 12 and the opposing end portion 16 such that the sticker liner 72 remains adhered only to pocket portion 38.

FIG. 6C depicts in perspective view the sticker of FIG. 6B folded along bisecting fold line 46 and the opposing end portion 16 adhered to a portion of the back surface 32 of the mounting section 12 such that sticker liner 72 remaining on pocket portion 38 is folded onto itself thereby creating a through-pocket 82.

FIG. 6D depicts in perspective view a sticker of FIG. 6A in which the pocket 82 was pre-assembled by use of an adhesive 31, typically by the sticker manufacturer or someone other than the person who mounts the sticker on the mounting surface. FIG. 6B and FIG. 6C are not used in the description of how FIG. 6D is reached from FIG. 6A. In this embodiment, cut line 78 is deleted, and cut line 80 is repositioned to cut line 80a at the border between the main portion 26 and the adhering portion 28 as seen in FIG. 6A. An adhesive 31 was applied between the front surface 86 of liner 72 in the area of adhering portion 28, and the front surface 86 of liner 72 in the opposing end portion 16. Pocket portion 38 was folded along bisecting line 46 bringing the front surface 86 of liner 72 in the area of adhering portion 28, and the front surface 86 of liner 72 in the opposing end portion 16 together, to be held by adhesive 31 to form pocket 82 between first section 38a and second section 38b. Liner 72 on the main portion 26 is shown ready to be removed by the consumer to expose adhesive 30 when mounting sticker 10 on a mounting surface.

Although FIGS. 6A and 6D were used to show that an adhesive 31 could be added during assembly instead of using pre-applied adhesive 30, this concept is not limited to the embodiment shown in FIGS. 6A and 6D. This same concept of deleting and moving cut lines, and preassembling and gluing the sticker at a manufacturing facility can also be incorporated in other sticker embodiments.

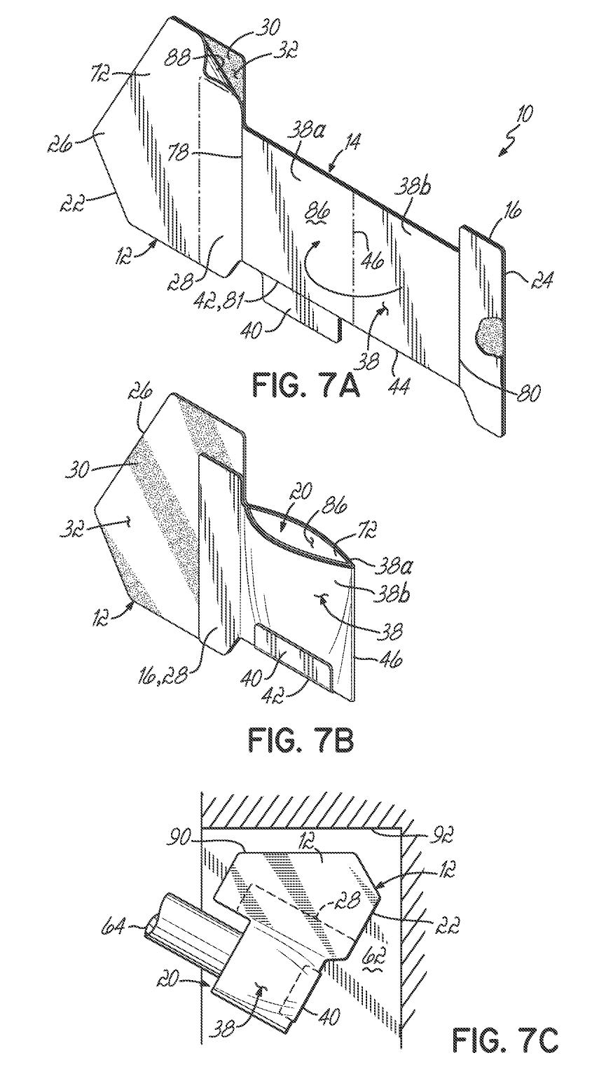

FIGS. 7A-7C depict in perspective and plan views a sticker 10 in accordance with yet another embodiment of the invention in which the sticker liner 72 is used to form a closed-bottom pocket 20. As shown in perspective view in FIG. 7A the sticker 10 has a front surface 24 and a back surface 32 with adhesive 30 applied to the back surface 32, as shown and/or described in prior embodiments. Sticker liner 72 has a front surface 86 and a back surface 88 with the back surface 88 adhered to the back surface 32 of sticker 10. The sticker 10 comprises a mounting section 12 and a pocket-forming section 14 extending integrally beyond the perimeter 22 of mounting section 12. Mounting section 12 comprises a main portion 26 used for adhering mounting section 12 to a mounting surface 62 (shown in FIG. 7C) and an adhering portion 28 used for adhering an opposing end portion 16 to mounting section 12. Pocket-forming section 14 comprises a pocket portion 38, the opposing end portion 16 opposite mounting section 12 with pocket portion 38 therebetween, and a lower flap section 40 extending from the lower perimeter 44 of pocket portion 38. Pocket-forming section 14 further comprises a fold line 42 separating lower flap section 40 from pocket portion 38 such that flap section 40 extends beyond the perimeter 44 of pocket portion 38 in a direction perpendicular to fold line 42. Upon folding lower flap section 40 along fold line 42, fold line 42 forms part of the lower perimeter 44 of pocket portion 38. Pocket-forming section 14 further comprises a fold line 46 bisecting pocket portion 38 in a direction perpendicular to fold line 42 into first and second sections 38a, 38b. Lower flap section 40 is positioned on one side of the bisecting fold line 46, i.e., extending from either the first section 38a (as shown) or the second section 38b. Sticker liner 72 is kiss-cut along cut lines 78, 80, and 81 with cut line 78 coinciding with the boundary between mounting section 12 and pocket portion 38, cut line 80 coinciding with the boundary between opposing end portion 16 and pocket portion 38, and cut line 81 coinciding with fold line 42 at the boundary between flap section 40 and pocket portion 38.

FIG. 7B depicts in perspective view the sticker 10 of FIG. 7A with portions of sticker liner 72 removed, namely from mounting section 12, opposing end portion 16, and lower flap section 40, and a portion of sticker liner 72 remaining adhered to pocket portion 38. The sticker 10 is folded along fold line 46 such that the back surface 32 of opposing end portion 16 is adhered to the back surface 32 of the adhering portion 28 of mounting section 12 and the front surface 86 of sticker liner 72 adhered to pocket portion 38 is folded onto itself. Flap section 40 is folded along fold line 42 such that the back surface 32 of flap section 40 is adhered to the front surface 24 of pocket portion 38. A closed-bottom pocket 20 is thereby formed extending beyond the perimeter 22 of mounting section 12. While this embodiment describes a sticker having a mounting section and a singular pocket external the mounting section, a plurality of pocket-forming sections extending beyond the perimeter of the mounting section may be provided to thereby form a plurality of pockets extending beyond the perimeter of the mounting section.

FIG. 7C depicts in front plan view the sticker 10 of FIG. 7B with a mounting section 12 having at least one straight edge 90 forming part of the perimeter 22 of mounting section 12. The sticker 10 is adhered to a mounting surface 62 such that the straight edge 90 of mounting section 12 is aligned with an aligning surface 92 thereby creating an angled pocket 20 whereby an object 64 can be inserted and removed therefrom. By way of example and not limitation, the aligning surface 92 may be a floor, a ceiling, a wall, or a cabinet. Additionally, a variety of other suitable surfaces may be used as an aligning surface 92, depending on the desired use of the sticker 10 and pocket 20.

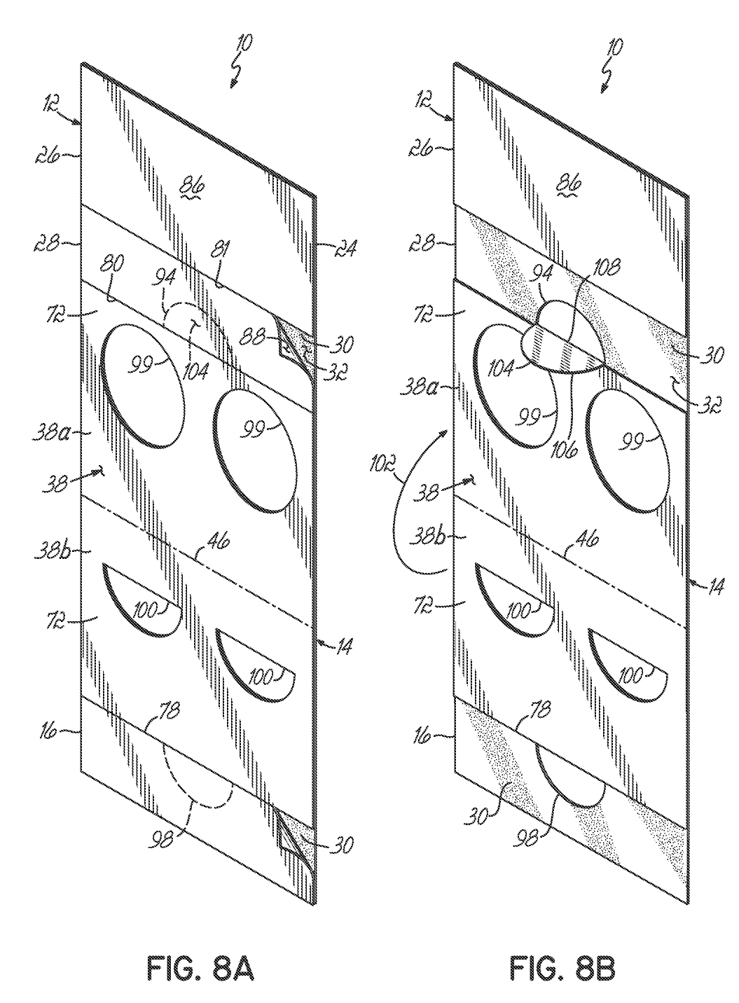

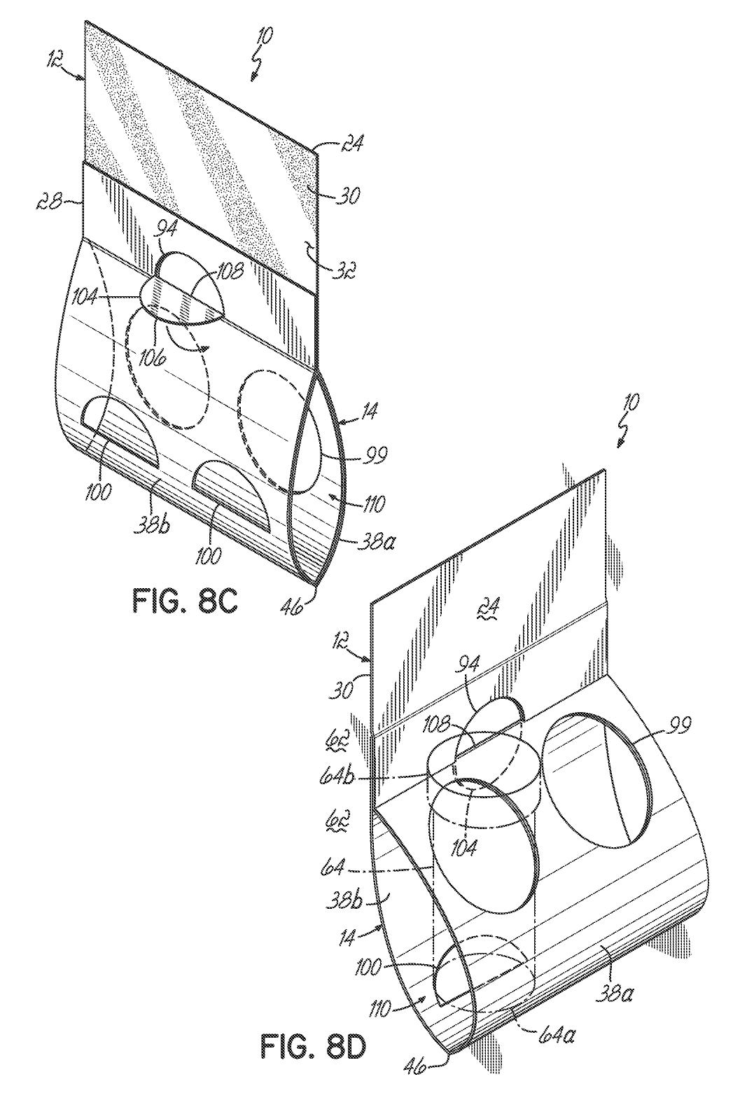

FIGS. 8A-8D depict in perspective views a sticker 10 in accordance with another embodiment of the invention in which the sticker liner 72 is used to form a pocket 110. As shown in the rear perspective view in FIG. 8A, the sticker 10 has a front surface 24 and a back surface 32 with an adhesive 30 applied to the back surface 32 of the sticker 10, as shown and/or described in prior embodiments. Sticker liner 72 has a front surface 86 and a back surface 88 with the back surface 88 releasably adhered to the back surface 32 of sticker 10 by adhesive 30. The sticker 10 comprises a mounting section 12 and a pocket-forming section 14 adjacent to mounting section 12. Mounting section 12 comprises a main portion 26 and an adhering portion 28. The pocket-forming section 14 comprises a pocket portion 38 and an opposing end portion 16 opposite mounting section 12 with pocket portion 38 therebetween. The sticker liner 72 has a kiss-cut line 81 at the boundary between the main portion 26 and the adhering portion 28, a kiss-cut line 80 at the boundary between mounting section 12 and pocket portion 38, and a kiss-cut line 78 at the boundary between pocket portion 38 and opposing end portion 16. Pocket portion 38 further comprises a bisecting fold line 46 parallel to cut lines 78, 80, and 81 dividing the pocket portion 38 into first and second sections 38a, 38b.

Pocket portion 38 includes at least one object aperture 99 (two object apertures 99 are depicted) in first section 38a. Pocket portion 38 further includes in the second section 38b a respective opposing aperture 100 for and registered with each object aperture 99. Apertures 99, 100 are formed through both the sticker 10 and the sticker liner 72. Opposing end 16 includes a flap opening 98 of a desired geometric shape having one straight sided lying essentially along the interface between opposing end 16 and second section 38b. Flap opening 98 may be formed through just the sticker 10, or flap opening 98 may be fully formed during the manufacturing process or cut lines may be formed in the desired geometric shape and the sticker material therein left in a loosely perforated state for the consumer to remove during assembly to create the flap opening 98. As shown, opening 98 may be a semi-circle, the diameter of which is parallel to and approximately along cut line 78, which is essentially positioned at the interface between opposing end 16 and second section 38b. In a further embodiment, the diameter of semi-circular opening 98 may be situated such that its mid point is approximately coincident with the midpoint of cut line 78.

Registered with the flap opening 98 is a flap 104 located in the adhering portion 28, adjacent the interface between the adhering portion 28 and the first section 38a. Flap 104 is formed by a cut line 94 together with a fold line 108 essentially lying along the adjacent interface. The flap 104 has the same desired geometrical shape as flap opening 98, but in a flipped image (i.e., a mirror image relative to a horizontal axis) and has the same or smaller dimension as flap opening 98. The mirror image straight side at the interface forms the fold line 108, as seen in FIG. 8B. In the embodiment shown flap 104 is a semi-circular flap that is sized to pass through the flap opening 98. The cut line 94 may be kiss-cut through the sticker 10 but not the liner 72 or may be cut through both the sticker 10 and liner 72.

FIG. 8B depicts in rear perspective view the sticker 10 and liner 72 of FIG. 8A in which portions of sticker liner 72 are removed from the adhering portion 28 and the opposing end portion 16 exposing adhesive 30. Flap 104 has a flap back surface 106 with the adhesive there exposed by removal of the liner 72. Flap opening 98, which was hidden in FIG. 8A, is now visible in FIG. 8B. Arrow 102 shows the direction in which the sticker is foldable upon itself at bisecting fold line 46.

FIG. 8C depicts the sticker 10 of FIG. 8B in rear perspective view after folding along bisecting line 46 in the direction of arrow 102 to create a pocket 110. Pocket 110 is open at the sides and closed at the top and bottom, and the interior is accessible through aperture(s) 99 for receiving objects 64. The opposing end 16 is adhered to the adhering portion 28 by the adhesive 30 on the back surfaces 32 thereof, with the interface between opposing end 16 and second section 38b in substantial alignment with the interface between adhering portion 28 and first section 38a. Flap 104 is folded at fold line 108 and passed through flap opening 98 to adhere back surface 106 having exposed adhesive 30 thereon to the front surface 24 of the second section 38b of pocket portion 38. Use of flap 104 provides extra strength to the closure of pocket 110. Another portion of sticker liner 72 has been removed to expose the adhesive 30 on the backside of the main portion 26 to enable mounting of sticker 10 to a mounting surface 62.

FIG. 8D depicts in front perspective view the sticker 10 of FIG. 8C mounted to a mounting surface 62, such as a wall, by the adhesive 30 on the main portion 26. An object 64, such as a cylindrical prescription bottle, is shown in phantom inserted into pocket 110 through an object aperture 99 with the inserted end 64a resting in and restrained by the opposing aperture 100 to stabilize it in the pocket 110, for example, to prevent it from slipping sideways out of pocket 110. The non-inserted end 64b is shown extending outside the pocket 110.

The angle at which an object 64 would rest relative to the viewer is dependent on the orientation that the sticker 10 is mounted relative the mounting surface 62. In FIG. 8D, object 64 stands essentially upright as shown due to pocket 110 being situated partially against mounting surface 62 such that the interior of pocket 110 lies in front of the plane of the mounting surface. If sticker 10 were mounted at the bottom of a mounting surface 62, such as the bottom edge of a cabinet face, such that pocket 110 hangs below the mounting surface 62, the interior of pocket 110 would be essentially centered with the plane of the mounting surface, similar to the orientation depicted in FIG. 8C. Object 64 inserted into object aperture 99 would then lie at an angle, making the top of the object more visible to the user.

FIGS. 8A through 8D depict features of one embodiment but the invention is not so limited. Features depicted in this embodiment may be combined with features of other described embodiments or altered by features described in other embodiments. For example, the use of adhesive 30 on the back surfaces 32 of both the adhering portion 28 and the opposing end portion 16 is not required. Adhesive at either location will work to close the sticker into the pocket shape.

Also, the flap 104 and flap opening 98 can be used in other embodiments, such as FIG. 6, to provide extra strength and they can be of any shape and quantity. Also, the object apertures 99 may be of any shape and quantity, and may be registered with opposing apertures 100 or may be used without opposing apertures.

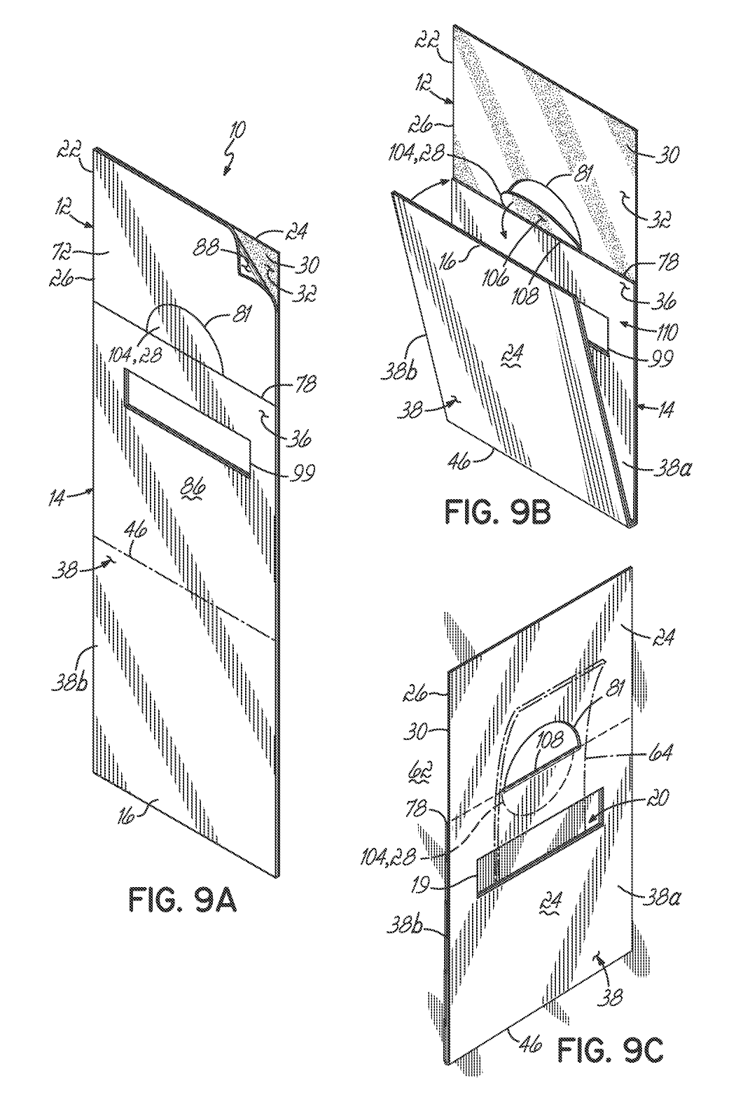

Yet another embodiment of a sticker 10 of the invention is depicted in FIGS. 9A through 9C. Similar to the embodiments of FIGS. 7 and 8, sticker 10 comprises one integral piece, maintains a liner 72 in a pocket portion 38 to form a pocket, which in this embodiment is a pocket 110, and has a flap 104 for closing the pocket. However, instead of flap 104 passing through a flap opening in an opposing end portion, to adhere to the pocket portion and thereby add strength to the closure provided primarily between an adhering portion and opposing end portion, in this embodiment, flap 104 is the sole means of closure for pocket 110. This embodiment is particularly suited to applications that have a less strenuous adhering requirement for the pocket 110 such as when pocket 110 is intended to receive objects of light weight, such as adhesive bandages or coupons. The embodiment of FIGS. 9A-9C is further described below.

FIG. 9A depicts in rear perspective view a sticker 10 adhered to a sticker liner 72. The sticker 10 has a front surface 24 and a back surface 32 with adhesive 30 applied to the back surface 32, as shown and/or described in prior embodiments. Sticker liner 72 has a front surface 86 and a back surface 88 with the back surface 88 releasably adhered to the back surface 32 of sticker 10. The sticker 10 comprises a mounting section 12 and a pocket-forming section 14 extending integrally beyond the perimeter 22 of mounting section 12. Mounting section 12 comprises a main portion 26 used for adhering mounting section 12 to a mounting surface 62 (FIG. 9C) and a flap 104 which serves as the adhering portion 28 for adhering to opposing end portion 16 of pocket-forming section 14. Sticker 10 further comprises a cut line 81 to create flap 104, and which also forms the border between main portion 26 and adhering portion 28. Cut line 81 is depicted as an arc for forming a semi-circular flap 104, but other shapes are contemplated, such as described above for FIGS. 8A-8D. Cut line 81 may be kiss-cut through sticker 10 only, or it may cut through liner 72, as shown. Sticker liner 72 has a kiss-cut line 78 coinciding with the interface between mounting section 12 and pocket-forming section 14 of sticker 10. The geometric shape of flap 104 includes a straight side that essentially lies along that same interface, with the ends of cut line 81 intersecting the interface. Consequently, if cut line 81 extends through liner 72, then liner 72 may be removed from the adhering portion 28 (flap 104) separately from the liner 72 adhering to main portion 26. Pocket-forming section 14 comprises a pocket portion 38, and an opposing end portion 16 opposite mounting section 12 that forms an integral part of pocket portion 38. Thus, pocket forming section 14 and pocket portion 38 are co-extensive in this embodiment. Pocket-forming section 14 further comprises a fold line 46 bisecting pocket portion 38 in a direction parallel to cut line 78 into a first section 38a and a second section 38b. Pocket portion 38 further comprises an object aperture 99 in first section 38a cut through both the sticker 10 and the sticker liner 72.

FIG. 9B depicts in rear perspective view the sticker 10 of FIG. 9A with a portion of sticker liner 72 removed from mounting section 12. The sticker 10 is folded along fold line 46 such that the front surface 86 of sticker liner 72 is folded onto itself. Sticker 10 further comprises a fold line 108 for flap 104 that is essentially coincident with the interface between mounting section 12 and pocket-forming section 14. Fold line 108 is further defined by the end points of cut line 81. Flap 104 (adhering portion 28) is folded along fold line 108 such that the back surface 106 is positioned to be adhered to the front surface 24 of the opposing end portion 16 in the second section 38b of pocket portion 38. A through pocket 110, oriented in a side position as shown, is thereby formed extending beyond the perimeter 22 of mounting section 12. While this embodiment describes a sticker having a mounting section and a singular pocket extending beyond the mounting section, a plurality of pocket-forming sections extending beyond the perimeter of the mounting section may be provided to thereby form a plurality of pockets extending beyond the perimeter of the mounting section.

FIG. 9C depicts in front perspective view the sticker 10 of FIG. 9B. The flap 104 (adhering portion 28) is adhered to pocket portion 38 thereby providing a closure for the pocket 110, and upon mounting, is positioned between the pocket portion 38 and the mounting surface 62. An object 64 is depicted in phantom inserted into a pocket 110 through object aperture 99. Object 64 may be, for instance, an adhesive bandage in its package. Object 64 can be inserted and removed as desired.

It may be appreciated that embodiments herein depict either a closed-bottom pocket 20, a through-pocket 82, or a side-open/top-bottom-closed pocket 110 with aperture access, but the invention is not limited solely to those configurations. A lower flap section 40 may be eliminated from an embodiment to form a through-pocket 82, or a lower flap section 40 may be added to close off the bottom of a through-pocket 82. Side flaps could also be added to a pocket 110 to close the sides. In addition, multiple pockets 20, 82, 100 or any combination thereof may be formed within and/or extending from the perimeter of a mounting section 12.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. An adhesive-backed sticker for adhering to a mounting surface and forming a pocket comprising:
a mounting section comprising a main portion and at least one adhering portion along a perimeter of the mounting section, the mounting section further having a front surface and a back surface with an adhesive applied to the back surface for adhering at least the main portion of the mounting section to a mounting surface,
at least one pocket-forming section extending beyond the perimeter of the mounting section adjacent the adhering portion, and comprising a pocket portion, a bisecting fold line dividing the pocket portion into a first section adjacent the adhering portion and a second section remote from the adhering portion, and an opposing end portion opposite the adhering portion and either adjacent to the second section or partially coincident with the second section,
adhesive applied to the opposing end portion or the adhering portion, or both, wherein the pocket portion is foldable at the bisecting fold line for adhering the opposing end portion and the adhering portion to each other whereby a pocket is formed between the first section and the second section of the pocket portion.

2. The sticker of claim 1 wherein the opposing end portion is adjacent the second section and the pocket portion is intermediate to the adhering portion and the opposing end portion.

3. The sticker of claim 2 wherein the mounting section and the pocket-forming section are formed from a single integral piece, and the pocket portion has a front surface and a back surface with an adhesive applied to the back surface, and further comprising a sticker liner adhered to the back surface of the pocket portion such that upon folding the pocket portion along the bisecting fold line, the sticker liner is folded upon itself to form a through-pocket.

4. The sticker of claim 3 wherein the pocket-forming section further comprises a lower flap section having a front surface and a back surface with an adhesive applied to the back surface, wherein the lower flap section extends beyond a lower perimeter of one of the first or second sections of the pocket portion with a fold line therebetween, wherein the lower flap section extends from the lower perimeter in a direction parallel to the bisecting fold line such that upon folding the pocket portion along the bisecting fold line, the back surface of the lower flap section is adapted to be folded along the fold line and its back surface adhered to the other of the first or second sections of the pocket portion thereby forming a closed-bottom pocket.

5. The sticker of claim 4 comprising a plurality of pocket-forming sections.

6. The sticker of claim 4 wherein the perimeter of the mounting section comprises at least one straight edge for aligning the mounting section with an aligning surface such that when the aligned mounting section is adhered to the mounting surface, the closed-bottom pocket rests at a desired angle relative to the aligning surface.

7. The sticker of claim 3 comprising a plurality of pocket-forming sections.

8. The sticker of claim 3 wherein the perimeter of the mounting section comprises at least one straight edge for aligning the mounting section with an aligning surface such that when the aligned mounting section is adhered to the mounting surface, the pocket rests at a desired angle relative to the aligning surface.

9. The sticker of claim 3 further comprising at least one object aperture in one of the first or second sections of the pocket portion through which an object can be partially inserted to hold said object in the pocket.

10. The sticker of claim 9 further comprising at least one opposing aperture in the other one of the first or second sections of the pocket portion and registered with the at least one object aperture.

11. The sticker of claim 10 having a plurality of object apertures and opposing apertures.

12. The sticker of claim 10 further comprising a flap in the adhering portion adjacent the first section and having adhesive on a back surface thereof, and a corresponding flap opening in the opposing end portion sized to permit the flap to pass through the flap opening upon adhering the opposing end portion and the adhering portion to each other, whereby the back surface of the flap is adapted to adhere to the front surface of the pocket portion.

13. The sticker of claim 12 having a plurality of flaps and flap openings.

14. The sticker of claim 3 further comprising a flap in the adhering portion adjacent the first section and having adhesive on a back surface thereof, and a corresponding flap opening in the opposing end portion sized to permit the flap to pass through the flap opening upon adhering the opposing end portion and the adhering portion to each other, whereby the back surface of the flap is adapted to adhere to the front surface of the pocket portion.

15. The sticker of claim 14 having a plurality of flaps and flap openings.

16. The sticker of claim 2 wherein the mounting section and the pocket-forming section are formed from a single integral piece,
wherein the pocket portion has a front surface and a back surface with an adhesive applied to the back surface,
wherein the pocket-forming section further comprises a lower flap section extending beyond a lower perimeter of one of the first or second sections of the pocket portion and in a direction parallel the bisecting fold line with a lower fold line between the pocket portion and the lower flap section,
wherein the pocket-forming section further comprises an upper flap section extending beyond an upper perimeter of both the first and second sections of the pocket portion and in a direction parallel the bisecting fold line with an upper fold line between the pocket portion and the upper flap section,
wherein the lower and upper flap sections each have a front surface and a back surface with an adhesive applied to each back surface,
wherein the upper flap section is foldable along the upper fold line to adhere the back surface of the upper flap section to the back surface of both the first and second sections of the pocket portion such that upon folding the pocket portion along the bisecting fold line, the front surface of the upper flap section is folded onto itself, and wherein the lower flap section is foldable along the lower fold line to adhere the back surface of the lower flap section to the front surface of the other one of the first or second sections of the pocket portion, thereby forming a closed-bottom pocket.

17. The sticker of claim 16 comprising a plurality of the pocket-forming sections.

18. The sticker of claim 16 wherein the perimeter of the mounting section comprises at least one straight edge for aligning the mounting section with an aligning surface such that when the aligned mounting section is adhered to the mounting surface, the pocket rests at a desired angle relative to the mounting surface.

19. The sticker of claim 2 wherein the sticker is a two-piece sticker with the mounting section and the pocket-forming section formed from separate pieces, wherein the pocket-forming section has a front surface and a back surface, a second end portion adjacent the first section such that the pocket portion is intermediate the opposing and second end portions, and wherein an adhesive is applied to the back surface of at least one of the second or opposing end portions such that upon folding the pocket portion along the bisecting fold line, the back surfaces of the second and opposing end portions are adhered to each other or to the adhering portion.

20. The sticker of claim 19 wherein the pocket-forming section further comprises a lower flap section extending beyond a lower perimeter of one of the first or second sections of the pocket portion with a lower fold line therebetween, wherein the lower flap section extends in a direction parallel to the bisecting fold line,
wherein an adhesive is applied to the back surface of the lower flap section such that upon folding the lower flap section along the lower fold line, the back surface of the flap section is adhered to the front surface of the other one of the first or second sections of the pocket portion thereby forming a closed-bottom pocket.

21. The sticker of claim 19 comprising a plurality of pocket-forming sections and a respective plurality of adhering portions.

22. The sticker of claim 19 wherein the perimeter of the mounting section comprises at least one straight edge whereby the straight edge is aligned with an aligning surface such that when the mounting section is adhered to the mounting surface, the pocket rests at a desired angle relative the aligning surface.

23. An adhesive-backed sticker for adhering to a mounting surface and forming a pocket comprising:
at least two mounting sections having a front surface and a back surface with an adhesive applied to the back surface of each for adhering the mounting sections to a mounting surface,
at least one pocket-forming section having a front surface and a back surface with an adhesive applied to the back surface, and further having a main portion and a lip portion with a fold line therebetween,
wherein the main portion is intermediate the at least two mounting sections,
wherein the lip portion extends beyond a perimeter of the main portion not bound by the two mounting sections,
wherein a sticker liner is adhered to the pocket-forming section,
wherein upon adhering the at least two mounting sections to the mounting surface, a through-pocket is formed between the mounting surface and the pocket-forming section in registry with the main portion, and
wherein the lip section is foldable along the fold line away from the mounting surface to provide a radiused edge for insertion of an object into the through-pocket.

24. A two-piece adhesive-backed sticker for adhering to a mounting surface and forming a pocket comprising:
a mounting section having a perimeter, a front surface, and a back surface with an adhesive applied to the back surface for adhering at least a portion of the mounting section to a mounting surface, wherein the mounting section further comprises an opening within the perimeter,
a separate pocket-forming section having a front surface and a back surface and further comprising a pocket portion and a flap section with a fold line therebetween, wherein the flap section extends beyond a perimeter of the pocket portion in a direction perpendicular to the fold line,
wherein the pocket-forming section is foldable along the fold line such that either the pocket portion or the flap section is insertable through the opening of the mounting section,
wherein the back surface of either the pocket portion or the flap section inserted through the opening is adherable to a portion of the back surface of the mounting section.

25. The sticker of claim 24 wherein the pocket portion is insertable through the opening of the mounting section such that the back surface of the pocket portion is adherable to the back surface of the mounting section, whereby upon adhering the mounting section onto the mounting surface, a pocket is formed between the mounting surface and the front surface of the pocket portion.

26. The sticker of claim 25 wherein the flap section is foldable away from the mounting surface to provide a radiused edge for insertion of an object into the pocket.

27. The sticker of claim 26 comprising a plurality of pocket-forming sections and a respective plurality of openings within the perimeter of the mounting section.

28. The sticker of claim 24 wherein the flap section is insertable through the opening of the mounting section such that the back surface of the flap section is adherable to the back surface of the mounting section, and wherein the pocket portion further comprises a pocket, whereby upon adhering the mounting section onto the mounting surface, a pocket is positioned external the mounting section with the mounting section intermediate the mounting surface and the pocket.

29. The sticker of claim 28 comprising a plurality of pocket-forming sections and a respective plurality of openings within the perimeter of the mounting section.

30. The sticker of claim 1 wherein the mounting section and the pocket-forming section are formed from a single integral piece, the opposing end portion is partially coincident with the second section, the pocket portion has a front surface and a back surface with an adhesive applied to the back surface, and the adhering portion is a flap foldable at the interface between the mounting section and the first section, and
further comprising a sticker liner adhered to the back surface of the pocket portion such that upon folding the pocket portion along the bisecting fold line, the sticker liner is folded upon itself to form a through-pocket and the flap is foldable to adhere to the front surface of the pocket portion to provide a closure to the through-pocket.

31. The sticker of claim 30 further comprising at least one object aperture in the pocket portion through which an object can be partially inserted to hold said object in the pocket.

32. The sticker of claim 31 having a plurality of object apertures.

33. The sticker of claim 30 having a plurality of flaps.

34. An adhesive-backed sticker for adhering to a mounting surface and forming a pocket comprising:
a mounting section comprising a main portion and at least one adhering portion along a perimeter of the mounting section, the mounting section further having a front surface and a back surface with an adhesive applied to the back surface for adhering at least the main portion of the mounting section to a mounting surface,
at least one pocket extending beyond the perimeter of the mounting section adjacent the adhering portion, and the pocket formed from a pocket-forming section comprising a pocket portion, a bisecting fold line dividing the pocket portion into a first section adjacent the adhering portion and a second section remote from the adhering portion, and an opposing end portion opposite the adhering portion and either adjacent to the second section or partially coincident with the second section,
adhesive applied between the opposing end portion and the adhering portion, wherein the pocket portion is folded at the bisecting fold line and the opposing end portion and the adhering portion adhered to each other thereby forming the pocket between the first section and the second section of the pocket portion.

35. The sticker of claim 34 wherein the opposing end portion is adjacent the second section and the pocket portion is intermediate to the adhering portion and the opposing end portion.

36. The sticker of claim 35 wherein the mounting section and the pocket-forming section are formed from a single integral piece, and the pocket portion has a front surface and a back surface with an adhesive applied to the back surface, and further comprising a sticker liner adhered to the back surface of the pocket portion such that upon folding the pocket portion along the bisecting fold line, the sticker liner is folded upon itself to form a through-pocket.

37. The sticker of claim 36 wherein the pocket-forming section further comprises a lower flap section having a front surface and a back surface with an adhesive applied to the back surface, wherein the lower flap section extends beyond a lower perimeter of one of the first or second sections of the pocket portion with a fold line therebetween, wherein the lower flap section extends from the lower perimeter in a direction parallel to the bisecting fold line such that upon folding the pocket portion along the bisecting fold line, the back surface of the lower flap section is adapted to be folded along the fold line and its back surface adhered to the other of the first or second sections of the pocket portion thereby forming a closed-bottom pocket.

38. The sticker of claim 37 comprising a plurality of pocket-forming sections.

39. The sticker of claim 37 wherein the perimeter of the mounting section comprises at least one straight edge for aligning the mounting section with an aligning surface such that when the aligned mounting section is adhered to the mounting surface, the closed-bottom pocket rests at a desired angle relative to the aligning surface.

40. The sticker of claim 36 comprising a plurality of pocket-forming sections.

41. The sticker of claim 36 wherein the perimeter of the mounting section comprises at least one straight edge for aligning the mounting section with an aligning surface such that when the aligned mounting section is adhered to the mounting surface, the pocket rests at a desired angle relative to the aligning surface.
